(19) United States
(12) Patent Application Publication
(10) Pub. No.: US 2022/0275800 A1
(43) Pub. Date: Sep. 1, 2022

(54) Method for Operating a Variable-Speed Electrohydraulic Pump, Computing Unit and Variable-Speed Electrohydraulic Pump

(71) Applicant: Robert Bosch GmbH, Stuttgart (DE)

(72) Inventor: Richard Bauer, Erlabrunn (DE)

(21) Appl. No.: 17/675,547

(22) Filed: Feb. 18, 2022

(30) Foreign Application Priority Data
Mar. 1, 2021 (DE) 10 2021 201 895.5

(51) Int. Cl. F04B 49/20; F04B 49/06; F04B 49/10; F04B 17/03

(52) U.S. Cl. CPC F04B 49/20; F04B 49/065; F04B 49/106; F04B 17/03; B66F 9/22

(57) ABSTRACT

A system and method of operating a variable-speed electrohydraulic pump, in which a pump delivery mechanism having an adjustable control volume is driven by an electric machine, includes activating the variable-speed electrohydraulic pump with a specific control volume and a specific speed, such that a specific volume flow is provided. The method includes obtaining control information for an actuator which indicates an increase in the volume flow and increasing the speed and reducing the control volume in response to the obtained control information. The method includes activating the variable-speed electrohydraulic pump to increase the volume flow after increasing the speed and reducing the control volume.

This application claims priority under 35 U.S.C. § 119 to patent application no. DE 10 2021 201 895.5, filed on Mar. 1, 2021 in Germany, the disclosure of which is incorporated herein by reference in its entirety.

The present disclosure relates to a method for operating a variable-speed electrohydraulic pump, in which a pump delivery mechanism with an adjustable control volume is driven by an electric machine, a computing unit for this purpose, such a variable-speed electrohydraulic pump and a machine herewith.

### BACKGROUND

Electrohydraulic pumps have pump delivery mechanisms (hydraulic delivery unit) and an electric machine (motor), wherein the pump delivery mechanism is driven by the electric machine. The electric machine in turn is typically activated by a control unit or controller and supplied with voltage and current. By using a frequency converter, for example, the rotational speed of the electric machine and therefore of the pump can be varied, so that it is possible to speak of a variable-speed electrohydraulic pump.

In addition to so-called constant-delivery pumps, there are also adjustable pumps, in which the pump delivery mechanism has an adjustable displacement volume (or delivery volume) per working cycle, that is to say, for example, per stroke or revolution (also designated the control volume). This can be, for example, an axial piston pump with a swash plate, in which a pivot angle can thus be adjusted to set the control volume. A variable-speed electrohydraulic pump and its operation are described, for example, in DE 10 2014 001 981 A1.

### SUMMARY

According to the disclosure, a method for operating a variable-speed electrohydraulic pump, a computing unit, such a variable-speed electrohydraulic pump and a machine having the features of the disclosure are proposed. Advantageous refinements are the subject matter of the disclosure and the following description.

The disclosure deals with variable-speed electrohydraulic pumps, in which a pump delivery mechanism having an adjustable control volume for a pressure medium (or hydraulic fluid) is driven by an electric machine, as explained at the beginning. In such pumps, it is often desirable for reasons of efficiency to operate them at the lowest possible speed and to activate them accordingly and, in the process, to adjust a value for the control volume such that the pump provides a desired delivery or volume flow. At low speed, this typically means a (relatively) high value of the control volume. The control volume can be, for example, predefined via a pivot angle if an axial piston pump with a swash plate is involved, as mentioned at the beginning. This type of operation is preferred in particular when the pump is idling, since a high efficacy and therefore a high efficiency of the pump is achieved.

A certain disadvantage here is, however, a lack of or low dynamics. An increase in load leads to a pressure dip, which the pump must compensate for with a higher volume flow. Starting from a low speed but a high control volume, however, the electric machine must then accelerate against a (high) load torque of the pump delivery mechanism.

Against this background, it is proposed that, even before a load change or a pressure dip occurs, the speed is increased and the control volume is reduced. Here, the variable-speed electrohydraulic pump is therefore firstly operated with a specific value for the control volume and a specific value for the speed, so that a specific volume flow is provided as is needed, for example, for the current situation or operating phase. Here, this can be, for example, idling. Speed regulation can in particular be used also as a lower-order controller of a controller of the volume flow or of the pressure. To this end, the electric machine in turn typically comprises a converter or frequency converter, which must be activated appropriately, i.e. the frequency to be output there is adjusted according to a desired speed.

The value of the speed can, for example, be as low as is possible or permitted for the pump used (the minimum speed is typically predefined by the design by the pump delivery mechanism and the hydraulic unit), wherein care must be taken that the maximum possible control volume must then still suffice for the desired volume flow. It is also possible, for example, for the control volume to be adjusted to the maximum value and the speed to be adapted according to the desired volume flow, to the extent that this is possible. This can be done, for example, via a control unit of the variable-speed electrohydraulic pump or another suitable computing unit, which activates the electric machine or the converter appropriately for this purpose. Depending on the type of pump, the control unit can, for example, also be integrated structurally in the converter.

Within the context of the disclosure, use is now made of the fact that during the use of such a variable-speed electrohydraulic pump, for example in a (mobile) machine (or working machine), there is generally an input unit, of which the actuation is ultimately associated with a change, in particular an increase, of the desired or required volume flow which is to be provided by the pump. Such an input unit can be, for example, a joystick (or lever), a steering wheel or a pedal of a mobile working machine (e.g. a forklift truck or a telehandler), with which a dynamic working unit (e.g. an arm of the telehandler) is to be moved hydraulically as a component of the machine. Depending on the movement, this requires an increase in the volume flow in order, for example, to move the dynamic working unit against a load via a hydraulic cylinder, for example to lift an arm. To this end, the input unit controls an actuator such as, for example, a valve in order to increase a volume flow, which then leads to the change or increase in the (required) volume flow via the pump controller. Often, mobile working machines, if they are vehicles, are also driven hydraulically, so that the input unit can be, for example, a gas or accelerator pedal. Likewise, steering can be carried out hydraulically, then with a steering wheel, for example, as an input unit.

The input unit therefore outputs control information for an actuator (or, if appropriate, also for a plurality of actuators) (as a rule via a signal), wherein the control information indicates (at least indirectly) a change in the volume flow. Such control information is then detected or read, for example by the aforementioned control unit of the pump. As soon as it is determined or is possible to determine by using the control information that any increase in the volume flow (or an increase in load) is impending, it is in particular possible to react immediately by the speed being increased and the control volume being reduced. The control information can be evaluated by using, for example, the amplitude and/or the dynamics of the deflection of the input unit (that is to say, for example, how far and how quickly the joystick is moved). The increase in the speed can be made, for example, by an additive value of a setpoint for the frequency converter of the electric machine. The volume flow or a setpoint for this can initially still remain constant, at least substantially or approximately (it is therefore possible, for example, for a certain deviation of, for example, 5% still to be accepted). If, then, the actuator, that is to say, for example, the valve in the control block of the hydraulic system, has been actuated (i.e. has reacted to the control information) and the volume flow demand rises, the variable-speed electrohydraulic pump is activated automatically to increase the volume flow. This can then be carried out, for example, within the context of control that is used in any case, for example of the volume flow or pressure, with which the pressure dip is controlled out. The time between the actuation of the input unit and the reaction of the actuator, which usually elapses unused as latency or dead time, can then be used advantageously for the increase in the speed and the control volume reduction within the context of the disclosure. In other words, the speed is therefore increased and the control volume reduced before the actuator has reacted to the control information, and the variable-speed electrohydraulic pump is activated to increase the volume flow as soon as the actuator has reacted to the control information.

In this way, the speed of the electric machine is therefore increased even before the increase in load, so that when the increase in load occurs it is possible to react, for example with an increase in the control volume (which previously has certainly been reduced), which is considerably more quickly possible than increasing the speed of the electric machine from a low value against a (typically very high) load torque. Therefore, the dynamics of the variable-speed electrohydraulic pump are considerably increased. Use is made of the fact that the actuator reacts to the control information only with a certain delay (latency). This latency represents precisely that time which can be used for the pre-evaluation of the control information, in order to increase the dynamics.

After the operating phase with an increased volume flow has been completed, for example after the movement of the dynamic working unit has been completed, the pump can be switched to idling again by the speed being reduced and the control volume being increased. This can also be done, for example, by using the control information if it emerges therefrom that an increased volume flow is no longer needed, for example since an input which requires a movement of a component is no longer made. However, this can also be done without any such control information, for example within the context of normal control.

In addition to the method for operating the variable-speed electrohydraulic pump, the disclosure also relates to a computing unit, for example a control device or a control unit of such a variable-speed electrohydraulic pump which is set up, in particular by programming, to carry out a method according to the disclosure.

The disclosure likewise relates to a variable-speed electrohydraulic pump in which a pump delivery mechanism having an adjustable control volume is driven by an electric machine, and which has a computing unit according to the disclosure.

Furthermore, the disclosure relates to a machine, in particular a mobile machine, for example a working machine such as a forklift truck or telehandler, having such a variable-speed electrohydraulic pump, at least one component which is driven by the pump, and an input unit for controlling the at least one component via an actuator. Such a component can be, for example, a dynamic working unit, a steering system and/or a traction unit, as already mentioned above by way of example.

To avoid repetitions, for further preferred refinements and advantages of pump and machine, reference should be made to the above explanations relating to the method, which here are correspondingly true.

In addition, the implementation of a method according to the disclosure in the form of a computer program or computer program product having program code for carrying out all the method steps is advantageous, since this gives rise to particularly low costs, in particular if an executing control device is also used for further tasks and is therefore present in any case. Suitable data carriers for providing the computer program are in particular magnetic, optical and electrical stores, such as, for example, hard drives, flash memories, EEPROMs, DVDs and so on. A download of a program via computer networks (Internet, intranet and so on) is also possible.

Further advantages and refinements of the disclosure can be gathered from the description and the appended drawings.

It goes without saying that the features mentioned above and those still to be explained below can be used not only in the respectively specified combination but also in other combinations or on their own without departing from the scope of the present disclosure.

The disclosure is illustrated schematically in the drawing by using an exemplary embodiment and will be described extensively below with reference to the drawing.

### BRIEF DESCRIPTION OF THE DRAWINGS

FIG. 1 shows, schematically, a machine having a variable-speed electrohydraulic pump in which a method according to the disclosure can be used.

FIG. 2 shows, schematically, a sequence of a method according to the disclosure in a preferred embodiment.

### DETAILED DESCRIPTION

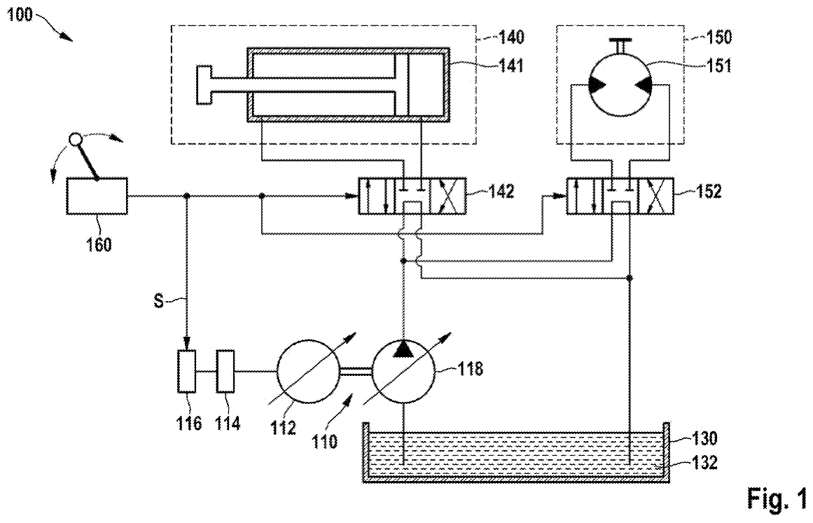

FIG. 1 illustrates, schematically, a machine 100 having a variable-speed electrohydraulic pump 110, in which a method according to the disclosure can be used or carried out. The machine 100, which is illustrated here only purely schematically with the relevant components, can in particular be a mobile working machine such as, for example, a telehandler.

The variable-speed electrohydraulic pump 110 has a variable-speed electric machine 112 (e.g. an electric motor), which can be activated and operated via a frequency converter 114 by a computing unit 116 designed as a control unit. The electric machine 112 is coupled to a pump delivery mechanism 118 with an adjustable control volume (indicated by the arrow). The control volume can, for example, likewise be set via the control unit 116 (depending on the type of pump, this is done, for example, by setting a pivot angle, as already mentioned). In this way, via the control unit 116, via the setting or predefinition of the speed (via a frequency on the frequency converter) and the control volume, the variable-speed electrohydraulic pump 110 can be activated and operated such that it provides a specific volume flow.

By way of example, the machine 100 has two components 140 and 150, which are driven by means of or via the variable speed electrohydraulic pump 110. The component 140 is, for example, a dynamic working unit (for example a shovel arm) having a hydraulic cylinder 141. The component 150 is, for example, a traction drive with a hydraulic motor 151. Also provided is an input unit 160 designed as a joystick by means of which, by way of example, both the components 140 and the component 150 can be activated, for example by the joystick being moved to the left or right or forward or backward. It goes without saying that further input units can also be provided, for example an accelerator pedal for activating the component 150. Likewise, further components which are driven via the variable-speed electrohydraulic pump 110 can be provided.

In order then to be able to activate the components 140, 150 by means of the input unit 160, actuators 142, 152 formed as valves are provided, which can be actuated by a control signal S from the input unit 160 in order to supply the hydraulic cylinder 141 and the hydraulic motor 151 (as part of the components 140, 150) with hydraulic fluid 132 provided by the variable-speed electrohydraulic pump 110 and, for example, taken from a tank 130. It goes without saying that a plurality of valves can also be integrated in a valve block (it is precisely in mobile working machines that there are often many different hydraulically operated components, which can also be activated separately).

If one of the components 140, 150 is to be actuated or moved, an increase in load occurs and an increased volume flow is required from the pump 110 in order to compensate for the pressure dip. The control unit 116 then detects the control signal S, for example continuously, in order to be able to determine whether an increase in the volume flow is impending because of an actuation of the input unit 160.

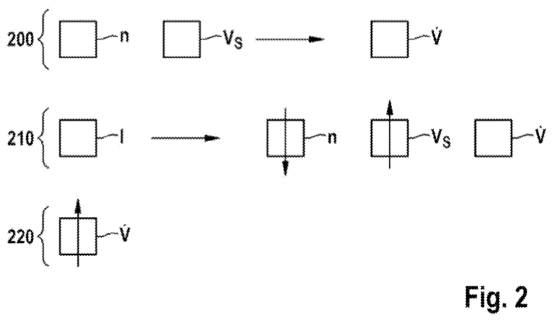

FIG. 2 illustrates, schematically, a sequence of a method according to the disclosure in a preferred embodiment, such as can be carried out, for example, in the machine shown in FIG. 1.

Here, to begin with in an operating phase 200, for example idling, the variable-speed electrohydraulic pump is operated with a specific value for the speed n of the electric machine and for the control volume Vₛ, so that a specific volume flow V is established. Here, the speed n is chosen to be (as far as possible) low, the control volume Vₛ is relatively high, on the other hand, so that a high efficiency is achieved.

During this, according to step 210, the control signal (cf. FIG. 1) is monitored for control information I for an actuator (or else for a plurality of actuators). If this control information I then indicates an (impending) increase in the volume flow, since the input unit is actuated in order, for example, to move the dynamic working unit, the speed n is reduced and the control volume Vₛ is increased (without delay) while the volume flow \dot{V} which is produced thereby more remains the same or unchanged (since the actuator has not yet reacted). The increase in the speed and the reduction in the control volume are therefore carried out in particular during a latency or dead time of the actuator.

Only after that, according to step 220, is the variable-speed electrohydraulic pump activated to increase the volume flow \dot{V}, for example by increasing the control volume. This can be done as a result of the actuation of the actuator, for example within the context of control which is carried out in any case. Because of a high speed but low control volume which are present during the increase in load which then has to be managed, the dynamics of the variable-speed electrohydraulic pump, that is to say the speed with which the volume flow can be increased—and therefore the dynamic working unit is moved or set moving—are considerably higher than without this previous adaptation of speed and control volume. The manipulated variable for the control is therefore preferably the speed of the pump.

What is claimed is:

1. A method of operating a variable-speed electrohydraulic pump, in which a pump delivery mechanism having an adjustable control volume is driven by an electric machine, comprising:
activating the variable-speed electrohydraulic pump with a specific control volume and a specific speed, such that a specific volume flow is provided;
obtaining control information for an actuator which indicates an increase in the volume flow;
increasing the speed and reducing the control volume in response to the obtained control information; and
activating the variable-speed electrohydraulic pump to increase the volume flow after increasing the speed and reducing the control volume.

2. The method according to claim 1, wherein increasing the speed and reducing the control volume comprises:
increasing the speed and reducing the control volume such that the volume flow remains at least substantially constant.

3. The method according to claim 1, wherein activating the variable-speed electrohydraulic pump comprises:
activating the variable-speed electrohydraulic pump using speed control.

4. The method according to claim 3, wherein the electric machine is operated by means of a converter, and wherein increasing the speed comprises:
using an additive term to form a setpoint for the converter.

5. The method according to claim 1, wherein the control information comprises or is derived from control information transmitted from an input unit to the actuator.

6. The method according to claim 5, wherein the variable-speed electrohydraulic pump is used to operate at least one component of a mobile machine.

7. The method according to claim 6, wherein:
the input unit is used to control the at least one component via the actuator (142, 152); and
the at least one component is one of a dynamic working unit, a steering system, and a traction unit.

8. The method according to claim 1, wherein:
the speed is increased and the control volume is reduced before the actuator has reacted to the control information; and
the variable-speed electrohydraulic pump is activated to increase the volume flow as soon as the actuator has reacted to the control information.

9. A system, comprising:
a control unit configured to
activate a variable-speed electrohydraulic pump with a specific control volume and a specific speed, such that a specific volume flow is provided;
obtain control information for an actuator which indicates an increase in the volume flow;
increase the speed and reduce the control volume in response to the obtained control information; and
activate the variable-speed electrohydraulic pump to increase the volume flow after increasing the speed and reducing the control volume.

10. The system of claim 9, further comprising:
the variable-speed electrohydraulic pump, the variable-speed electrohydraulic pump including a pump delivery mechanism with an adjustable control volume driven by an electric machine.

11. The system of claim 10, wherein the system is a mobile machine system, the mobile machine system further comprising:
at least one component configured to be driven by the variable-speed electrohydraulic pump; and
an input unit configured to control the at least one component via the actuator.

12. The system of claim 9, further comprising:
a memory including program instructions stored therein, wherein the control unit is configured to execute the program instructions to
activate the variable-speed electrohydraulic pump with the specific control volume and the specific speed, such that the specific volume flow is provided;
obtain the control information for the actuator which indicates the increase in the volume flow;
increase the speed and reduce the control volume in response to the obtained control information; and
activate the variable-speed electrohydraulic pump to increase the volume flow after increasing the speed and reducing the control volume.
